(19) United States
(12) Patent Application Publication
(10) Pub. No.: US 2009/0288496 A1
(43) Pub. Date: Nov. 26, 2009

(54) Acoustic Arrangement

(75) Inventors: Pekka Hiismäki, Hamina (FI); Pekka Hyvönen, Siltakyla (FI); Sauli Koukkari, Jyvaskyla (FI)

Correspondence Address: BIRCH STEWART KOLASCH & BIRCH, PO BOX 747, FALLS CHURCH, VA, 22040-0747, US

(73) Assignee: JUSTIFLOW OY, JYVASKYLA (FI)

(21) Appl. No.: 11/922,105

(22) PCT Filed: Jun. 16, 2006
(86) PCT No.: PCT/FI2006/000212

§ 371 Date: Aug. 13, 2008

(30) Foreign Application Priority Data
Jun. 16, 2005 (FI) FI2005/000288

(51) Int. Cl. G01F 1/66

(52) U.S. Cl. 73/861.28

(57) ABSTRACT

The invention concerns a flow metering techniques, which applies acoustic means and/or methods as embodied for an acoustic flow metering arrangement according to the invention. The flow metering can be implemented with an acoustic flow meter arrangement, which comprises a measuring section (1) provided with a sound source, at least two sound sensors and a reflector, being arranged so that the sound source of the acoustic flow meter arrangement and at least two sound sensors are arranged to mutual pre-defined distances in the measuring section. So, the determination of the sound velocity at rest (c) and the flow velocity (v), from the known distance between the sound source and the sensors, is obtainable from the values for sum (T_{SUM}) and difference (T_{DIF}) of the upstream and downstream transit times of sound between the sensor locations, by utilising the sound as directly propagated and as reflected.

The invention relates to special acoustic measurements in a general level, in which low frequency sound, propagating in the fundamental mode of the flow tube is used. In a more particular, the invention relates to a flow measurement arrangement according to the preamble of an independent claim thereof. The invention relates also to an acoustic flow meter as indicated in the preamble of an independent claim thereof. The invention relates also to an acoustic flow determination method in a flow channel according to the preamble of an independent method claim. The invention relates also to a software program product according to the preamble of an independent claim thereof. The invention relates to a flow measurement system according to the preamble of an independent claim thereof.

It is known that long wavelength sound propagating in the so called “piston mode” in a flow channel of rigid walls is a good choice for acoustic flow metering, since the speed of sound is the sum of the speed of sound at rest plus or minus the mean flow velocity in the measuring volume chosen. [B. Robertson. “Effect of arbitrary temperature and flow profiles on the speed of sound in a pipe”, J. Acoust. Soc. Am., Vol. 62, No. 4, pp. 813-818, October 1977 and B. Robertson, “Flow and temperature profile independence of flow measurements using long acoustic waves”, Transactions of ASME, Vol. 106, pp. 18-20, March 1984].

One of the obstacles of such measurement is how to distinguish the downstream and upstream propagating sound waves from each other. Directional filtering, as described in patents [FI 94909, U.S. Pat. No. 5,770,806], is one possibility. Achieving good results requires both amplitude and phase matching of four microphones over wide temperature range, which is very difficult to achieve in practice.

It is known as such to use differential mode sound for determining the sound velocity from the resonance frequency of a resonator, from the disclosure in the Internet in http://www.acoustics.org/press/150th/Garrett.html.

In addition to solving problems relating to the above-mentioned known techniques, it is an objective of the invention to improve the measurement accuracy and/or to speed up the flow determination. This is achieved by the flow meter arrangement arranged for a flow determination according to the embodiments of the invention.

An acoustic flow meter arrangement, comprising a measuring section according to the invention is characterized in an independent claim thereof. A measuring section according to the invention is characterized in an independent claim thereof. A sound reflector/attenuator according to the invention is characterized in an independent claim thereof. An acoustic flow metering method according to the invention is characterized in an independent method claim. A software program product according to the invention is characterized in an independent claim thereof. An acoustic flow meter system according to the invention is characterized in an independent claim thereof. A measuring section (1) provided with a sound source is characterized in an independent claim thereof. An acoustic flow meter arrangement for differential sound measurement is characterized in an independent claim thereof.

Other embodiments of the invention are illustratively embodied and indicated in the dependent claims. The embodiments of the invention are combinable in suitable part.

In a flow arrangement according to an embodiment of the invention, the flow measurement is arranged to occur in a flow channel comprising a measuring section. According to an embodiment of the invention, one end of the measuring section is designed to act as a reflector, returning a quantifiable echo of the wave entering from the measuring section side. The downstream and upstream sounds are decomposed from the measured sound signals of only two sound sensors based on the echo model. Thereby it becomes possible to determine the difference of the transit times between the sound sensors directly without determining first the downstream and upstream transit times separately. This is unlike any other acoustic transit time measurement using the same measurement volume in both directions. The invention relates also to an acoustic flow meter. The arrangement embodied in the invention can be embodied as a discrete but functional ensemble of the parts of the arrangement. However, in suitable part, such parts can be assembled to form a device, a flow meter. Data acquisition means, processor, a database, memory and a transmission line for transferring measurement related data acquired by said data acquisition means can be at least partly assembled into the same cover for the device. The device can be a part of a system, where there are several flow meter arrangements in combination. According to an embodiment the invention, the system comprises communication means arranged to receive, transmit and/or store flow measurement related data. In an embodiment of the invention, the acoustic part of the arrangement comprises means arranged to generate an impulse to be sent into the measuring section of the arrangement by a first transducer. In an embodiment of the invention, the acoustic part of the arrangement comprises a second transducer means to obtain said impulse for a response to be formed and processed by a processor.

According to a very simple embodiment of the invention, for the reflector can be embodied as a sudden expansion of the flow tube cross-section. Thereby it is recommendable that the expanded tube section is lined with sound absorbing material in order to prevent any sound or echoes from further sections of the flow tube from entering the measurement section.

In a flow arrangement according to an embodiment of the invention, the measuring section can be provided with an inner wall dividing the measuring section in two parallel channels preferably of the same cross-sectional area. However, in an embodiment of the invention the cross-sectional areas are not limited only to the same values. In an embodiment of the invention the dual channel section comprises a piece of a special acoustic transmission line, capable of conveying both common mode sound and differential mode sound. Common mode sound is a combination of identical sound waves in both parallel channels. Differential mode sound is a combination of a certain sound wave in one channel and its contra sound in the other.

According to an embodiment of the invention, this differential mode sound combined with directional decomposition provides an ideal choice for flow measuring, because it is almost perfectly reflected from the cross section of the sudden end of the inner wall. Moreover, disturbing sound from outside of the measuring section gives a contribution to the common mode sound only, not in the differential mode sound. Accordingly a differential sound source, generating certain sound into one of the channels and its contra sound into the other, should be chosen. Likewise, and more importantly, according to an embodiment of the invention, differential sound sensors, insensitive to common mode sound are chosen.

According to an optional embodiment of the invention, a dual acoustic transmission line, can be used with a differential mode sound for determining the sound velocity from the resonance frequency of a resonator first, as known as such from http://www.acoustics.org/press/150th/Garrett.html, but in the embodiment of the invention, intricate phase measurements are made in a combination of a multi-frequency sound emission in the dual line.

The embodiments of the invention are now explained in detail, by referring to the following Figs. illustrating examples of the embodiments of the invention having thereby no intention to limit the invention by any means. In the Figs.,

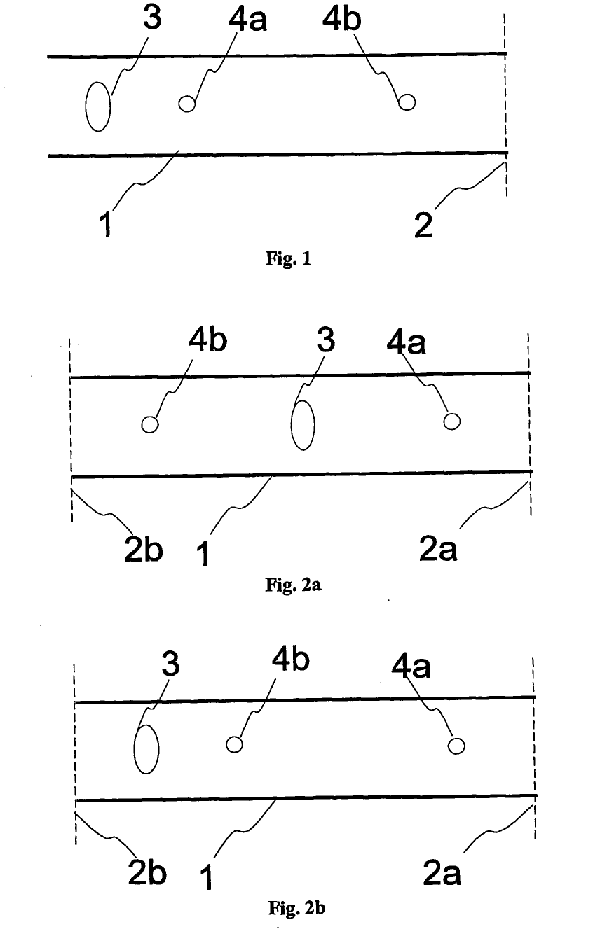

FIG. 1 illustrates a flow channel to be used for an embodiment of the invention,

FIG. 2a illustrates a flow channel geometry to be used for an embodiment of the invention,

FIG. 2b illustrates a flow channel geometry to be used for an embodiment of the invention,

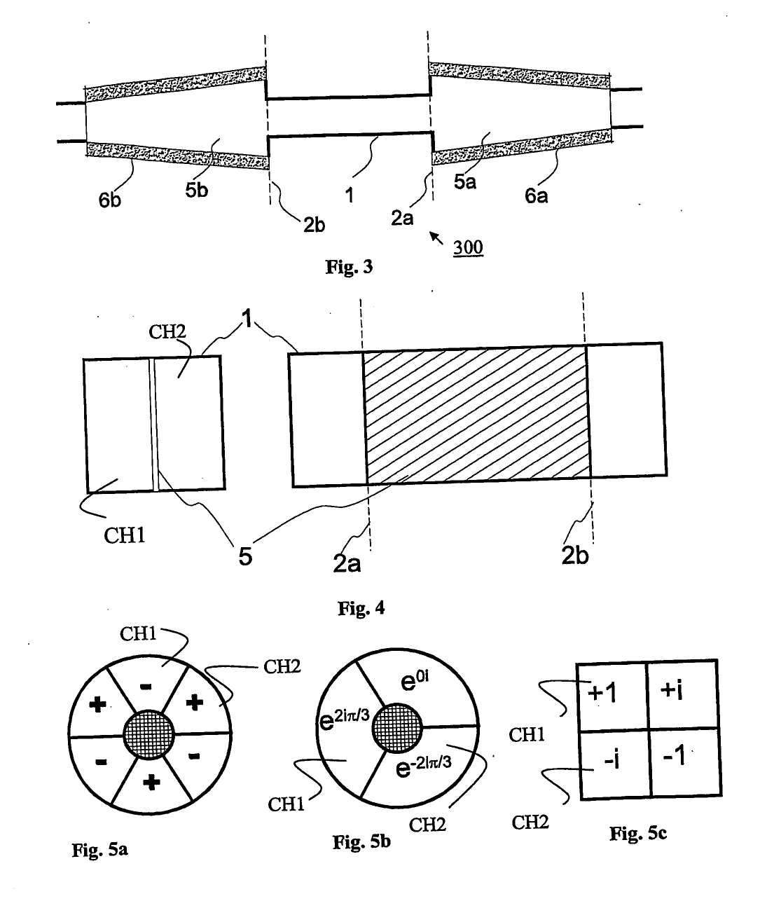

FIG. 3 illustrates a flow measurement arrangement according to an embodiment of the invention,

FIG. 4 illustrates a measuring section according to an embodiment of the invention,

FIG. 5a illustrates an example of a cross section of the measuring section according to an embodiment of the invention,

FIG. 5b illustrates another example of a cross section of the measuring section according to an embodiment of the invention,

FIG. 5c illustrates a further example of a cross section of the measuring section according to an embodiment of the invention,

FIG. 6 illustrates a method according to an embodiment of the invention, and

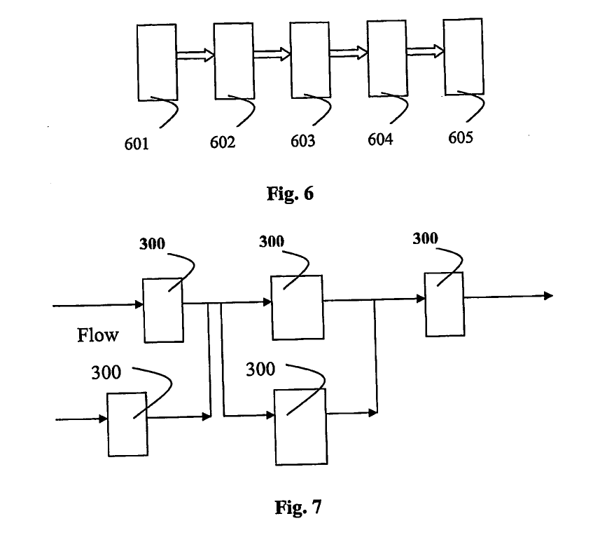

FIG. 7 illustrates a system according to an embodiment of the invention.

If otherwise not indicated for a particular Fig. or Figs., the same reference numerals are used in the different Fig(s). to indicate the same kind of parts, although the parts are not necessarily to be exactly the same. The various embodiments are shown as examples form the various embodiments of the invention, which shown as such are combinable in suitable part.

Let us first begin from the well known expressions for the downstream transit time T_{D} and upstream transit time T_{U} of sound propagating over flight path of length b in a flowing medium of sound speed at rest c and mean flow velocity v:

$${T}_{D} = \frac{b}{c + v} \\ {T}_{U} = \frac{b}{c - v} \qquad ( 1 )$$

c and v as a function of T_{D} and T_{U} are thus

$$c = \frac{1}{2} b ( {T}_{U}^{- 1} + {T}_{D}^{- 1} ) \\ v = \frac{1}{2} b ( {T}_{U}^{- 1} - {T}_{D}^{- 1} ) \qquad ( 2 )$$

By defining the transit time sum as T_{SUM}=T_{U}+T_{D} and the transit time difference as T_{DIF}=T_{U}−T_{D},

equation pair (2) can rewritten as

$$c = \frac{2 b}{{T}_{SUM} [ 1 - {( \frac{{T}_{DIF}}{{T}_{SUM}} )}^{2} ]} \\ v = \frac{{T}_{DIF}}{{T}_{SUM}} c \qquad ( 3 )$$

From the measurement point of view there is a significant difference between expressions (2) and (3). Extracting the best estimate for T_{DIF} directly from the measurement data, as in the preferred embodiments of the invention, instead of extracting separate estimates for T_{D} and T_{U} is expected to lead to a better estimate for v, too. Besides T_{DIF} one has, of course, to be able to determine T_{SUM} also. The transit time difference manifests itself in the phase difference at well-defined multiple frequencies of the two cross-power spectrums related to the downstream and upstream propagating sound waves. For this purpose, instead of emitting sound as bursts, in an embodiment of the invention, stationary multi-frequency sound as periodically repeated pseudorandom sequences are chosen so allowing precise phase measurement at a large number of discrete frequencies simultaneously. This choice also allows signal averaging, meaning that sensor signals from several consecutive periods are sampled and accumulated together in synchronism with the updating steps of the sound emission, before the signals are analyzed. Thereby the signal to noise ratio can be substantially improved.

A complex multi-frequency phase factor multiplied with appropriately chosen statistical weight vector represents a generalized cross power spectrum vector. Its Fourier transform appears as a generalized correlation function, the centre of which is marks the transit time in question. In what follows transit time determination is most often formulated as a multi-frequency phase measurement. The alternative correlation function approach is always implicated even when not explicitly stated.

FIG. 1 shows schematically a flow channel 1, which forms an acoustic transmission line. The channel is shown as a length-wise cross-section. The nature of the transmission line, namely simple or multiple, according to the respective embodiments of the invention, is irrelevant here for the understanding. Cross-section at the plane 2, indicated by a dashed line in the FIG. 1, in a perpendicular direction to the length wise direction represents an acoustic discontinuity, which allows the flow to pass fluently through it, but reflects a substantial part of the sound wave entering from left. The flow direction is irrelevant here for the simple example. A sound source 3 is shown in the FIG. 1 for emitting sound as periodic pseudorandom sequences. A first sound sensor 4a is positioned far enough from the sound source for making all higher modes except the piston mode to quench. A second sound sensor 4b is positioned at distance b from the first sound sensor. Each of the components (3, 4a, 4b) are matched to the type of the transmission line, meaning that each of them is just an ordinary transducer or sensor for a single transmission line, but generating/sensing differential mode sound only for a dual transmission line e.g.

Referring to FIG. 1 let the sound signal vectors of the first sensor and the second sensor be TM1 and TM2 respectively. These have been sampled at regular intervals, as controlled by the very same clock in an embodiment of the invention, which updates the signal to the sound source. However, in another embodiment of the invention the intervals can be synchronized with separate clocks or timers that have the sufficient synchronization. The number of components of these vectors is preferably a power of two, such as 2048 e.g. in order to be able to apply the most efficient Fast Fourier Transform=FFT algorithm. A skilled man in the art knows from that the power-of-two-selection is not actually limiting, but is chosen on the basis of the current computer utilizing algorithms, as the FFT included. By using this algorithm two complex-valued frequency domain vectors FM1 and FM2 are formed from TM1 and TM2 respectively.

The sound propagation back and forth over a flight path b in the frequency domain is represented by a propagation vector P, the components of which can be expressed as

Pₖ(1)=i {−γb+ikT_{SUM}(b)πN⁻¹}, (4)

where k is the index of the frequency channel, γ is a single absorption parameter or a group of parameters for allowing some frequency dependence and N is half the number channels in time domain vectors. The argument (1) of Pₖ(1) should be understood as (1·b) implying that relative path length 1 corresponds to the actual pathlength b.

The sound reflection at the reflector is represented by a reflection vector R, the frequency components of which are expressed as

Rₖ=ρexp(iβ), (5)

where ρ is a single echo amplitude parameter or a group of parameters for allowing some frequency dependence, and β is a single echo phase parameter or a group of parameters for allowing some frequency dependence. In particular, β should contain a term, proportional to k and/or to k², for taking into account that the precise location of the reflecting plane may be frequency dependent.

Both FM1 and FM2 can now be expressed as the superposition of the primary sound wave vectors FM1_{D} and FM2_{D} and the echoes FM1_{U} and FM2_{U}, as returned by the reflector

FM1=FM1_{D}+FM1_{U}=[1+P(1+ζ)R]FM1_{D}

FM2=FM2_{D}+FM2_{U}=[1+P(ζ)R]FM2_{D} (6)

The distance of the reflector from the second sound sensor is assumed to be ζb. The sub index_{D} refers to the primary sound wave and _{U} to the echo, implying that the primary sound wave propagates in downstream direction. However, length-wise flow direction, upstream or downstream, is quite irrelevant, and thus does not limit the embodiments of the invention. The decomposition of both sensor signals into primary wave and echo vectors is now given by

FM1_{D}=[1+P(1+ζ)R]⁻¹FM1FM1_{U}=FM1−FM1_{D}

FM2_{D}=[1+P(ζ)R]FM2FM2_{U}=FM2−FM2_{D} (7)

So far the expressions (7) contain quite many unknown parameters, most importantly T_{SUM}, others related to sound absorption and reflection. Phase factor vector

ph=arg(FM1_{U} F̅M̅2̅_̅{̅U̅}̅FM2_{D} F̅M̅1̅_̅{̅D̅}̅)

versus frequency channel index k, represents a straight line, the slope of which is proportional to T_{DIF}, if correct values for the parameters have been chosen. The unknown parameters related to absorption and reflection, are determined from the best fit of ph to a straight line model at zero flow velocity. As flow velocity is varied, only T_{SUM} and to a lesser extent the absorption parameters are supposed to change, while the rest of the parameters keep their values determined at zero flow.

For optimum data fitting one has to choose a good weighting scheme for depressing the importance of lower precision channels relative to the higher precision channels. Expression (9) shows one good choice for a weight vector w to be implemented as w² multiplier vector in the least square error sum for finding the best fit.

$$w = \frac{\vert FM 1 \vert \vert FM 2 \vert}{\sqrt{{\vert FM 1 \vert}^{2} + {\vert FM 2 \vert}^{2}}} \qquad ( 9 )$$

An alternative choice for w is obtained from the sound source spectrum and the propagation and echo models without the knowledge of measured sensor signals. As it can be deduced from equation (3), improving the relative accuracy of T_{SUM} beyond the relative accuracy of T_{DIF} makes no big difference in the accuracy of v. Accordingly, T_{SUM} does not have to be among the parameters to be obtained by the best fit of ph, but can be obtained from any other procedure leading to reasonable accuracy. One possibility is to implement directional filtering by forming a downstream vector and an upstream vector by adjusting the amplitudes of FM1 and FM2 for taking into account sensitivity imbalance and the sound absorption from one sensor to the other, by time-shifting these vectors relative to each other, and by subtracting them so that the result is a pure downstream or a pure upstream vector referred to the same point of definition. The time shift between these two directionally filtered vectors corresponds to the flight time from the point of definition to the reflector and back, which is proportional to T_{SUM}. Here again the time shifts needed for filtering are T_{U} and T_{D}, which are not known until both T_{SUM} and T_{DIF} are known, leading to an iterative process, according to an embodiment of the invention. Each new value for T_{SUM} can be introduced for obtaining a new value for T_{DIF} from fitting eq. (8), leading to new values for T_{U} and T_{D}, and so on.

According to another embodiment of the invention, another possibility is to implement another reflector at the opposite end of the measuring section as indicated by the dashed lines 2a and 2b in FIG. 2a and FIG. 2b representing the two basic choices of locating the sound source either between or outside of the sound sensors. For simplicity, having no intention to restrict or limit the scope of the invention the configuration example of FIG. 2a is symmetric with the sound source 3, as in a further embodiment of the invention, together with an optional third sound sensor at the same streamwise location, placed at the centre and the two sound sensors 4a, 4b at the same distance from the sound source. There are several ways to obtain T_{SUM} and T_{DIF} in this case according to an embodiment of the invention. Let the emitting signal to the sound source, or the signal detected with the optional third microphone, be denoted by the time domain vector TS and the corresponding frequency domain vector, obtained by Fourier transform operation, by FS. One can now form two phase vectors

ph_{DIF}=arg(FM2 F̅M̅1̅)

ph_{SUM}=arg(FM1FM2 F̅S̅F̅S̅) (10)

associated with T_{DIF} and T_{SUM} over the flight paths from the sound source to both sound sensors. In this case the reflected signals at both ends are retarded relative to the unreflected signals by the sum of upstream and downstream flight times from the sensor to the reflector and back. Therefore, no explicit echo model beyond the assumption that the same model applies at both ends is needed. T_{DIF} and T_{SUM} are obtained from the slopes of the phase vectors versus frequency channel k, by implementing a proper weight vector for emphasizing the higher precision frequencies against the lower precision ones. T_{SUM} can also be obtained from the set of resonance frequencies corresponding to an odd number of wavelengths from one reflector to the other one and back, possibly corrected for the exact phase change at the reflection.

So far no explicit description of the sound reflectors has been given. The basic version of an embodiment of the invention is exemplary embodied in FIG. 3. The reflectors 2a and 2b are represented by a sudden change of the flow channel cross-section at the both ends of the measuring section 1, including the sound source and sound sensors though not explicitly shown in the FIG. 3. This has been accomplished with two expansion chambers 5a and 5b, lined with sound absorbing material 6a and 6b in order to prevent any sound from the outer sections of the flow tube from entering the measuring section 1. The expansion chambers are properly referred to as reflector/attenuators.

As an alternative to the reflector/attenuators shown in FIG. 3, an example according to another embodiment of reflectors is given in FIG. 4. The flow channel or tube 1 is divided by an inner wall (5) into two parallel channels. A differential sound source, in other words an acoustic dipole source is e.g. an oscillating diaphragm causing positive sound pressure at one side of the diaphragm and simultaneously negative sound pressure of equal amplitude at the other can be used as a sound source 3 (FIGS. 1, 2a, 2b). Such a differential sound source, when installed in the inner wall, generates a differential sound mode in the dual acoustic transmission line formed by the inner wall 5 section of the flow tube 1. In differential sound mode certain sound wave is propagating in one of the parallel channels and its counter sound in the other, both as the fundamental piston modes of the divided channel. The end cross-sections of the inner wall, marked as 2a and 2b in FIG. 4, perform as almost perfect reflectors for this differential sound, since beyond these cross-sections both sound waves would completely cancel each other. On the other hand disturbing sound from further sections of the flow tube appears in the dual transmission line section as the common mode sound, propagating as identical waves in both parallel channels. Therefore differential sound sensors, tuned to sense the differential sound mode only and installed at the inner wall e.g., would not respond at all to such common mode disturbances.

According to an embodiment of the invention, in which a well-defined reflector is desired at one end of the measuring section only, the inner wall should not stop at the other end abruptly, but in a gradual manner.

In an alternative embodiment of the invention, a differential sound source or sensor are replaced by a pair of matched ordinary sound sources or sensors, coupled to operate in opposite phase.

Apart from the basic dual channel acoustic transmission line, with two sub-channels, as previously embodied in the FIGS. 1, 2a, 2b, 4, more complicated inner wall configurations, as illustrated in FIGS. 5 a . . . 5c, can be also be used. FIG. 5a embodies an example of a measuring section 1 having a cross section of an annular ring at the location indicated by the line 2a and/or 2b, but the core of the annular ring is excluded from the sound and/or flow system as such, in an embodiment of the invention. In another embodiment, the core of the annular ring can be used for a passage to wires and/or location tunnel of microphones, temperature sensors, pressure sensors, gas composition sensors etc. to sense the environmental quantities acting in the channel and having potentially an effect on to the measurement result. The ring is divided in an even number of parallel channels, sub channels, every second, marked with +, grouped to convey certain sound wave and the rest, marked with −, grouped to convey the counter sound.

As referring to FIG. 5c, the diagonal (or the annularly shaped measuring section symmetrically divided into four) the differential sound modes are mutually orthogonal, and thus in a reflection do not interfere each other in the measurement. This is an advantage as the sound for both modes can be freely selected independently. (Double, a reflection symmetry in the both diagonal direction) The + and − signs indicate that the sound waves are mutually in the same phase in the equally marked channels, and in a opposite phase in the oppositely signed channels.

According to an embodiment of the invention the sound cancellation does not have to be the sum of two opposite phase waves, but can be accomplished from three, four, or more waves of the same amplitude, but their phases differing by 360/3, 360/4 or 360/(n>4) degrees respectively. FIG. 5b embodies an example of an annular ring divided in three sectors carrying a three-phase sound wave analogically to three-phase electric current. FIG. 5c embodies a square tube example of a four-parallel-channel division, carrying a four-phase sound wave in the embodiment. The phase markings in these Figs. are mutually relative markings indicating the relative phases between the channels in the particularly embodied measuring section cross-section, and thus not necessarily the absolute phases. These multi-phase sound transmission lines, as embodied in FIG. 5b for instance, are just examples and can be varied in many ways. A skilled man in the art when read and understood the application text can vary the transmission lines without leaving the scope of the embodied embodiment of the invention.

In an embodiment the cylinder formed into the measuring section in FIGS. 5a and/or 5b can be filled with differently sound conducting first material than the second material expected to flow in sub-channels CH1 and CH2. The speed of sound can be much higher or lower for the first material. In such a manner it is possible to use phase sifts for a particular sound and thus arrange interference effects.

FIG. 6 embodies an example of an acoustic flow metering method according to an embodiment of the invention. The method comprises a phases of emitting sound into a measuring section defined by at least one wall in a flow channel, which is divided by said at least one wall into a number of sub-channels, so that a sound source is arranged to emit (601) a low frequency sound into a first sub-channel of the flow channel at a certain first phase. The method comprises also phases in which

said low frequency sound is emitted (602) in a second phase (+) into the second sub-channel (CH2) of the flow channel,

returning (603) an echo back into the measuring section, from a sudden at least at one end (2a, 2b) discontinuity location of said wall (5), said discontinuity location arranged to operate as a reflector,

detecting (604) said emitted sound from said sound source (3) at a distance (b), by at least one sound sensor (4a, 4b) between the sound source and a reflector end (2a, 2b) and

determining (605) the sound velocity at rest (c) and the flow velocity (v) from the known distance of the sound sensors and the obtained values for sum (T_{SUM}) and difference (T_{DIF}) of the upstream and downstream transit times of sound between the sensor locations.

FIG. 7 embodies an example of an acoustic flow metering system according to an embodiment of the invention. In such an exemplary system there can be several flow-measuring arrangements according to FIGS. 1-5c connected by the flow tubes, or a net-work of flow tubes, illustrated by the lines with arrows there between the blocks so that some of the arrangements 300 are in series in the flow in one embodiment, but instead or in addition to the series connected arrangements 300, in another embodiment there can be also arrangements 300 that are connected in parallel, in respect to the flow, the direction of which as indicated by the arrow. Each or some of the arrangements according to the embodiment can comprise a measuring section 1 (not shown in FIG. 7 in detail), according to the FIGS. 1, 2a, 2b, 3 and/or 4. Although the same reference number in FIG. 7, the arrangements 300 can be different in their mechanical, electrical and/or acoustical properties, but can be adapted according to the flowing material in the flow for the particular flow rate range in the tube. In an embodiment of the invention such a measuring section 1 is comprised by a flow measuring arrangement, which can be embodied as a reflector/attenuator in its simplest variant, if the sensors for the determination of the ambient conditions, power supplies as well as data acquisition electronics and processing units are not considered to be counted for the simplicity. Although in the FIG. 7 the reference numeral 300 has been used, a skilled man knows from the text as read that in such a system also other embodiments of the invention can be used for the flow measuring arrangement, such as embodied for example in FIGS. 4-5c.

However, the embodiments with several channels having more than two sub-channels may not bring benefits over the basic dual transmission line, in a normal flow measurement determination. But they can be useful for instance in cases in which redundant measurements are needed at a different frequencies, or the measurement data is needed very rapidly in a short duration measurement for a momentarily flow rate values in a statistically more sufficient grounds for averaging for instance. Such conditions could be at least in theory met in conditions in which chemical reaction or other reason that causes sound absorption in the channel at certain frequencies are expected to occur. Utilisation of such embodiments of the invention, where the measuring section is implemented with the help of many parallel sub-channels, can be particularly useful in large tubes or pipes, or arrays thereof, for providing using high frequency sounds and/or achieving a desired accuracy within a short measuring section.

The digital processor, auxiliary electronics and appropriate temperature and pressure sensors for generating, measuring and/or processing the data into flow readings, to be used for the flow measurement, are not shown in the Figs. for clarity reasons, although are serving a multitude of various needs of various embodiments of the invention.

1. An acoustic flow meter arrangement, comprising a measuring section (1) provided with a sound source (3), at least two sound sensors (4a, 4b) and a reflector (2a, 2b), characterized in that the sound source (3) of the acoustic flow meter arrangement, at least two sound sensors (4a, 4b) and the reflector (2a, 2b) are arranged to mutual pre-defined distances in the measuring section so that the determination of the sound velocity at rest (c) and the flow velocity (v), from the known distance between the sound source (3), reflector (2a, 2b) and the sensors (4a, 4b), is obtainable from the values for sum (T_{SUM}) and difference (T_{DIF}) of the upstream and downstream transit times of propagating sound between the sensor locations (4a, 4b).

2. An acoustic flow meter arrangement according to claim 1, characterized in that in the acoustic flow meter arrangement comprises a measuring section (1) defined by at least one wall (5) in a flow channel, which is divided by said at least one wall (5) into a number of sub-channels (CH1, CH2), comprises a sound source (3) arranged to emit a low frequency sound into a first sub-channel (CH1) of the flow channel at a certain first phase (−),
the flow channel comprises a second sub-channel (CH2) of the flow channel into which sub channel (CH2) the sound source (3) is arranged to emit said low frequency sound in a second phase (+),
said wall (5) comprises at least at one end (2a, 2b) a sudden discontinuity location arranged to operate as a reflector for returning an echo back into the measuring section,
between the sound source and a reflector end (2a, 2b) the channel comprises at least one sound sensor (4a, 4b) for detecting said emitted sound from said sound source (3) at a distance (b),

3. An acoustic flow meter arrangement according to claim 1, wherein said arrangement comprises sensors (4a, 4b) that are sampled synchronously with an updating steps of the emitted sound, for formation of respective sensor signals to be used for determination of the sum T_{SUM}, and difference T_{DIF}.

4. An acoustic flow meter arrangement according to claim 1, wherein the arrangement comprises means for determining T_{DIF}, the difference of the upstream and downstream transit times between the sensor locations from the slope of the best fit of the phase factor of a generalized cross power spectrum FM1_{U} F̅M̅2̅_̅{̅U̅}̅FM2_{D} F̅M̅1̅_̅{̅D̅}̅ to a straight line versus frequency.

5. An acoustic flow meter arrangement according to claim 1, wherein the arrangement comprises means for determining from the time shift of the corresponding generalized correlation function, and T_{SUM} in any conceivable way such as e.g. from the set of values of parameters leading to the best fit.

6. An acoustic flow meter arrangement according to claim 2, wherein in the measuring section
said wall (5) comprises at each end (2a, 2b) a sudden discontinuity location arranged to operate as a reflector for returning an echo back into the measuring section.

7. An acoustic flow meter arrangement according to claim 2, wherein in the measuring section, the sound source is located at the centre of the measuring section.

8. An acoustic flow meter arrangement according to claim 2, wherein in the measuring section and the first sound sensor (2a) is located at a certain distance upstream from the sound source and the second sound sensor (2b) at the same distance downstream from the sound source.

9. An acoustic flow meter arrangement according to claim 2, wherein the arrangement comprises means for determination of T_{DIF} from the slope of the phase vector of the cross power spectrum vector FM1 F̅M̅2̅ and/or T_{SUM} from any conceivable way, e.g. from the known inter-sensor and/or inter-reflector distances in the arrangement and the set of resonance frequencies corresponding to sound propagation from one reflector to the other one and back an integer number of times.

10. A sound reflector/attenuator for returning back into the measuring section of an acoustic flow meter arrangement nothing else but a predictable and quantifiable echo, characterized from
that it comprises an expansion chamber (5a, 5b) of sudden increase in the cross sectional area (2a, 2b) relative to the cross sectional area of the measuring section (1) and/or
that its inner surface is lined (6a, 6b) with sound absorbing material for preventing any sound from further sections of the flow tube from entering the measuring section.

11. An acoustic flow meter arrangement according to claim 2, wherein the arrangement comprises a sound source arranged to transmit sound as periodically repeated, pseudorandom noise sequences to propagate in each of the sub channel of the flow channel as the fundamental “piston mode”.

12. An acoustic flow meter arrangement according to claim 11, wherein the arrangement comprises a sound source that is of differential type.

13. An acoustic flow meter arrangement according to claim 11, wherein the arrangement comprises a sound source which is of dipolar type generating sound waves of the same amplitude but of the opposite phase into the two sides of the inner wall (5).

14. An acoustic flow meter arrangement according to claim 11, wherein the arrangement comprises at least one sound sensor, which is of differential type.

15. An acoustic flow meter arrangement according to claim 11, wherein the arrangement comprises at least one sound sensor, which is of differential type sensitive to the acoustic pressure difference between the inner wall and insensitive to the common acoustic pressure.

16. A measuring section (1), defined by at least one wall (5) in a flow channel, which is divided by said at least one wall (5) into a number of sub-channels (CH1, CH2), comprises a sound source (3) arranged to emit a low frequency sound into a first sub-channel (CH1) of the flow channel at a certain first phase (−), characterized in that in the measuring section comprises
the flow channel which further comprises a second sub-channel (CH2) of the flow channel into which sub channel (CH2) the sound source (3) is arranged to emit said low frequency sound in a second phase (+),
said wall (5) comprises at least at one end (2a, 2b) a sudden discontinuity location arranged to operate as a reflector for returning an echo back into the measuring section,
between the sound source and a reflector end (2a, 2b) the channel comprises at least one sound sensor (4a, 4b) for detecting said emitted sound from said sound source (3) at a distance (b), which are arranged to mutual pre-defined distances in the measuring section so that the determination of the sound velocity at rest (c) and the flow velocity (v), from the known distance between the sound source and the sensors, is obtainable from the values for sum (T_{SUM}) and difference (T_{DIF}) of the upstream and downstream transit times of sound between the sensor locations.

17. Measuring section of an acoustic flow metering arrangement according to claim 16, characterized from that the measuring section is divided into a number of parallel sub-channels.

18. Measuring section of an acoustic flow metering arrangement according to claim 17, characterized from that, in a plane perpendicular to direction of the flow, cross-sectional areas of said parallel sub-channels (CH1, CH2) are equal.

19. Measuring section of an acoustic flow metering arrangement according to claim 17, characterized from that in said measuring section, the phase sift at a certain sound frequency of the sound between two neighbouring sub-channels is different than 360°/said number of parallel channels.

20. Measuring section of an acoustic flow metering arrangement according to claim 17, characterized from
that the section is divided by a configuration of inner walls into an even number of parallel flow channels, grouped in alternating order into two groups of channels, one group for a certain sound wave and the other for its counter sound, and/or
that the section is divided by a configuration of inner walls into parallel channels or groups of channels forming a multiphase acoustic transmission line, with sound waves propagating in each of the parallel channels otherwise identical but the phase differing from the neighbouring channel by 2π/n

21. Measuring section of an acoustic flow metering arrangement according to claim 16, characterized from that in said measuring section the number of parallel sub-channels (CH1, CH2) is two.

22. Measuring section of an acoustic flow metering arrangement according to claim 21, characterized from that the measuring section comprises a microphone and/or a sound source.

23. An acoustic flow meter arrangement characterized in that it comprises a measuring section according to claim 16.

24. An acoustic flow meter characterized in that it is implemented by an acoustic flow meter arrangement according to claim 23.

25. An acoustic flow metering method, comprising a phase of emitting (601) sound into a measuring section (1) defined by at least one wall (5) in a flow channel, which is divided by said at least one wall (5) into a number of sub-channels, comprises a sound source (3) arranged to emit a low frequency sound into a first sub-channel (CH1) of the flow channel at a certain first phase (−), characterized in that the method comprises a phase in which
said low frequency sound is emitted (602) in a second phase (+) into the second sub-channel (CH2) of the flow channel,
returning (603) an echo back into the measuring section, from a sudden at least at one end (2a, 2b) discontinuity location of said wall (5), said discontinuity location arranged to operate as a reflector,
detecting (604) said emitted sound from said sound source (3) at a distance (b), by at least one sound sensor (4a, 4b) between the sound source and a reflector end (2a, 2b)
determining (605) the sound velocity at rest (c) and the flow velocity (v) from the known distance of the sound sensors and the obtained values for sum (T_{SUM}) and difference (T_{DIF}) of the upstream and downstream transit times of sound between the sensor locations.

26. A soft ware product on a computer readable media arranged to implement the method of claim 25.

27. An acoustic flow meter system, characterized in that, it comprises a flow meter arrangement according to claim 1.

28. An acoustic flow meter system according to claim 27, characterized in that, it comprises at least one of the following: data acquisition means, processor, a database, memory and a transmission line for transferring measurement related data acquired by said data acquisition means.

29. A measuring section (1) provided with a sound source (3), at least two sound sensors (4a, 4b) and a reflector (2a, 2b), characterized in that the sound source (3) of measuring section, at least two sound sensors (4a, 4b) and the reflector (2a, 2b) are arranged to mutual pre-defined distances in the measuring section so that the determination of the sound velocity at rest (c) and the flow velocity (v), from the known distance between the sound source (3), reflector (2a, 2b) and the sensors (4a, 4b), is obtainable from the values for sum (T_{SUM}) and difference (T_{DIF}) of the upstream and downstream transit times of propagating sound between the sensor locations (4a, 4b).

30. An acoustic flow meter arrangement, characterized in that it comprises a measuring section according to claim 1.

31. An acoustic flow meter arrangement for differential sound measurement, characterized in that it comprises a measuring section arranged for a differential sound measurement.
